(19) United States
(12) Patent Application Publication
(10) Pub. No.: US 2007/0241894 A1
(43) Pub. Date: Oct. 18, 2007

(54) Security system for mass transit vehicles

(76) Inventor: Jim A. Thrasher, Birmingham, AL (US)

Correspondence Address: Wm. Randall May;Allison, May, Alvis, Fuhrmeister & Kimbrough, LLC, 1300 Corporate Drive, Birmingham, AL, 35242, US

(21) Appl. No.: 11/405,706

(22) Filed: Apr. 18, 2006

(51) Int. Cl. G08B 13/18

(52) U.S. Cl. 340/552

(57) ABSTRACT

A point-of-entry security system for ground-based mass transit vehicles is disclosed. The invention employs an electromagnetic field generator attached to, or incorporated within, the doorframe or entranceway of said vehicle for sensing or detecting metallic objects being carried by passengers attempting to board the vehicle. The security system is designed to audibly and/or visibly alert the operator of said vehicle of a security breach. An optional wireless sending unit may be employed to transmit system data or security alerts to remote security personnel or to remote locations.

### FIELD OF THE INVENTION

This invention relates generally to security systems for ground-based transportation vehicles. More particularly, the present invention relates to a point-of-entry security system for use with mass transit surface and/or sub-surface vehicles such as motor coaches, subway cars, railcars, streetcars, trolleys, shuttle vehicles and the like.

### BACKGROUND OF THE INVENTION

Surface and sub-surface transit systems in the United States and elsewhere in the world presently carry 8-10 times as many passengers per year as aviation systems. Unlike airlines, where security checkpoints screen passengers and luggage, ground-based transit vehicles like buses, subways and passenger trains are designed to be easily accessible by passengers and are therefore much harder to secure and protect. Over the past several years, terrorists and terrorist organizations have committed horrific atrocities against innocent adults and children around the globe. Transit terrorism is a serious threat that harms people both directly, through injury and property damage, and indirectly by creating fear and confusion. Ground and sub-surface transportation systems, which often include enclosed spaces packed with people, can be, and have proved to be, tempting targets for terrorists and terrorist organizations. Indeed, top terrorist targets have included buses, subways, passenger trains, subway/train/bus stations, airport check in lines, and other venues where large numbers of people have tended to gather. Terrorist attacks on buses and train cars have been particularly lethal. In these attacks, terrorists have often used guns and conventional bombs to kill and injure civilians and to damage or destroy property. In the Jul. 7, 2005 London bus and subway bombings, 56 civilians were killed making this the deadliest attack in London since a V2 rocket killed 131 people in 1945. The Madrid train bombings of Mar. 11, 2004 killed 191 people and wounded 2,050 making this the worst terrorist assault in modern Spanish history and the deadliest assault by a terrorist organization against civilians in Europe since the Lockerbie bombings of 1988. In light of these and other recent atrocities, it is critical that mass transit systems around the globe use every means available to protect these systems and the innocent people who use them from such acts of corruption and violence. However, bringing airline-style security to buses, subways, passenger trains and other means of ground-based mass transit is virtually impossible. As stated, these systems are, by design, easily accessible by passengers and make frequent stops for embarkation and disembarkation thereby creating many opportunities for potential terrorist activities.

It would be expedient, therefore, to provide a point-of-entry security system for ground-based mass transit vehicles wherein passengers entering such vehicles can be easily screened for guns, knives, bombs or other heavy metal objects that could potentially be used as weapons.

### SUMMARY OF THE INVENTION

In view of the foregoing, it is a primary object of this invention to provide a method and apparatus for screening passengers and their packages for potential weapons as the passengers pass through the entranceway of a ground-based mass transit vehicle.

According to an embodiment of the invention, an entryway security system for ground-based mass transit vehicles comprises a pair of electromagnetic transmitting and receiving units mounted on either side of the vehicle doorway for detecting metallic objects as passengers attempt to board the vehicle. Interruption of the electromagnetic signals being transmitted across the vehicle doorway by said transmitting and receiving units would cause the receiving unit to send a signal to an electronic control unit thereby activating an audio and/or visual warning means detectable by the vehicle operator. An optional wireless sending unit provides wireless transmission of said warning signal or detection data to other remote security stations or locations as necessary or desired.

It is a primary object of the present invention to provide a vehicle mounted security system designed to alert the operator of a mass transit vehicle, and/or remote security personnel, of potential deadly weapons being carried by passengers.

An important advantage of the present invention is the provision of a security system for mass transit vehicles wherein said system is integrated into the vehicle doorframe or entryway thereby providing a means to screen each passenger during boarding.

Another important advantage of the present invention is the provision of a security system for mass transit vehicles that provides a means for a single operator to monitor and secure said vehicle at the point of entry.

Another advantage of the present invention is the provision of a security system for mass transit vehicles that reduces vulnerability of such vehicles to attacks or terrorist threats.

Another advantage of the present invention is the provision of a security system for mass transit vehicles that is specifically designed to discourage passengers from carrying metal objects that could be used as weapons.

A further advantage of the present invention is the provision of a security system that provides protection for drivers and operators of mass transit vehicles and provides a level of comfort for passengers of said vehicles.

Another advantage of the present invention is the provision of a security system for mass transit vehicles that is practical, cost effective, non-obtrusive, simple to install and maintain, and easy to operate.

Another advantage of the present invention is the provision of a security system for mass transit vehicles that gives the operator of said vehicle a means to scrutinize and/or evaluate potential security threats and the ability to confront or question passengers regarding any such threat prior to boarding and away from the vehicle.

Another advantage of the present invention resides in its potential for preventing deadly attacks on innocent children and adults.

A further advantage of the present invention resides in its ability to warn away potential or dangerous individuals who might try to bring weapons onto a mass transit vehicle.

A further advantage of the present invention is the provision of a warning system designed to provide an individual operator of a mass transit vehicle a method and means to screen and scrutinize passengers and their packages for potential weapons as they attempt to enter the vehicle and to broadcast such warning to remote security personnel.

### BRIEF DESCRIPTION OF THE DRAWINGS

The foregoing and other objects, features, and advantages of the present invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a perspective, partially sectioned, view of a preferred embodiment of the invention shown fully deployed within the entryway of a typical ground-based mass transit vehicle.

FIG. 2 is a perspective, partially sectioned, view of the embodiment of FIG. 1 showing the optional wireless sending unit and remote receiving/display unit.

FIG. 3 is a perspective, partially sectioned, view of the embodiment of FIG. 1 shown in a collapsed or retracted configuration.

FIG. 4 is a prospective view of the embodiment of FIG. 1 showing the device installed on a typical mass transit bus or motor coach.

FIG. 5 is a prospective view of the embodiment of FIG. 1 showing the invention used in conjunction with a typical subway car.

FIG. 6 is a prospective view of the embodiment of FIG. 1 showing the invention used in conjunction with a typical trolley.

FIG. 7 is a prospective view of the embodiment of FIG. 1 showing the invention used in conjunction with a typical passenger train car.

### DETAILED DESCRIPTION OF THE DRAWINGS

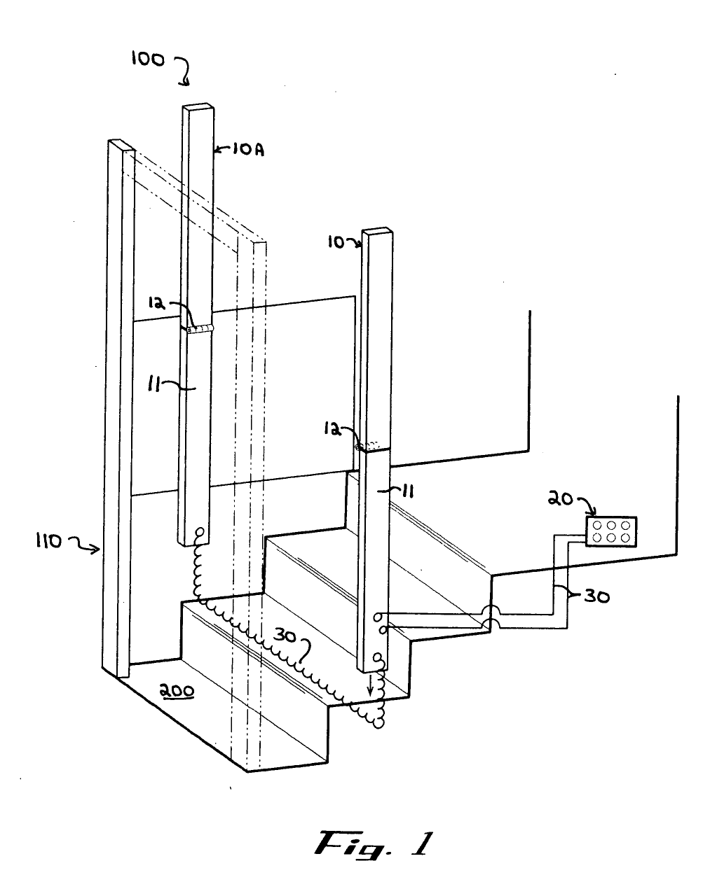

In accordance with an embodiment of the invention, FIG. 1 shows a point-of-entry security system 100 operably installed within the door or entranceway 110 of a typical ground-based mass transit vehicle 200. Said system 100 is designed to screen passengers and their packages for metallic objects that could potentially be used as weapons as the passengers pass through the narrow doorway 110 of said vehicle 200.

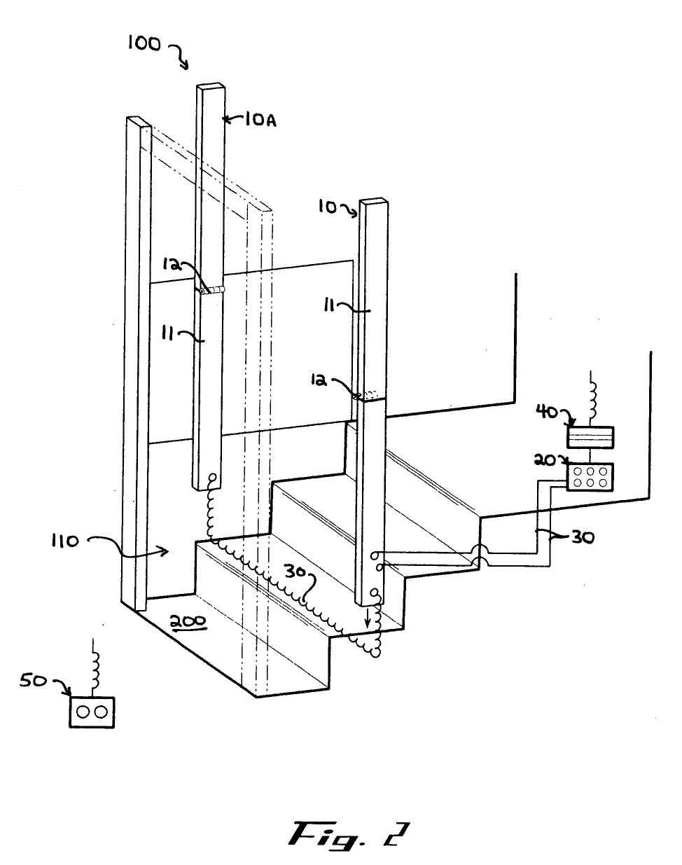

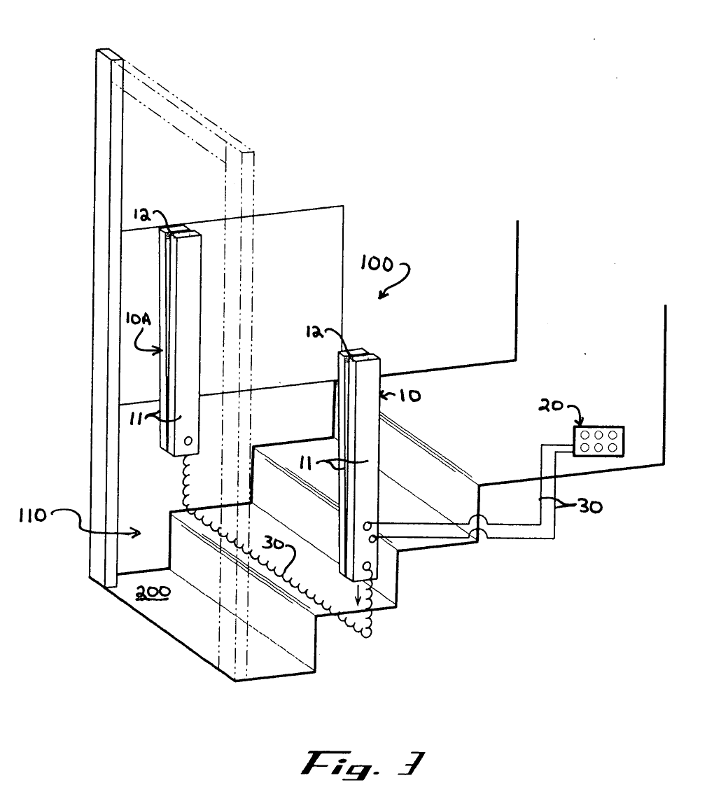

The security system 100 of FIG. 1 comprises a pair of electromagnetic sending/receiving units 10 & 10A mounted vertically at either side of said door or entranceway 110, an operator control panel 20, and power and control circuits 30 operably connected to said sending/receiving units 10 & 10A and to said operator control panel 20. The sending/receiving units 10 & 10A comprise vertical posts 11 having electromagnetic induction coils (not shown) housed therein capable of generating a balanced magnetic field between said sending/receiving units 10 & 10A for detection of metal objects entering said magnetic field. The control panel 20 is connected to an electric energy source (not shown) and is operably attached to said sending/receiving units 10 & 10A through said power and control circuits 30. Said control panel 20 thus provides a means for the vehicle operator to energize and activate said sending/receiving units 10, 10A and to control the sensitivity of said sending/receiving units 10 & 10A. Said control panel 20 also allows the vehicle operator to receive audible and/or visible warnings of metal objects detected by the magnetic field generated by said sending/receiving units 10 & 10A. As best seen in FIG. 3, the vertical post 11 of each electromagnetic sending/receiving unit 10, 10A further comprises a hinge joint 12 for collapsing and securing said post 11 during vehicle movement or when the security system 100 is not in use. As shown in FIG. 2, a wireless sending unit 40 may be incorporated into the security system 100 for sending detection data and/or warning signals to a remote receiver 50 as necessary to alert security personnel at remote or adjacent locations of potential problems.

In operation, a mass transit vehicle operator uses the control panel 20 to energize and activate the electromagnetic sending/receiving units 10 & 10A of said security system 100 and to set appropriate sensitivity levels for the magnetic field generated by said units 10 & 10A. As passengers attempt to board the vehicle 200 they are automatically screened for metal objects on their person or in their possession as they pass through the balanced magnetic field produced by said units 10, 10A. Upon encountering a metal object of sufficient size or density to trigger an imbalance in the magnetic field generated by said sending/receiving units 10, 10A, the control panel 20 audibly and/or visibly alerts the vehicle operator (and other remote security personnel if system 100 is so equipped) of the potential security breach. The operator may then detain said passenger for further search and/or questioning before allowing said passenger to board the vehicle 200.

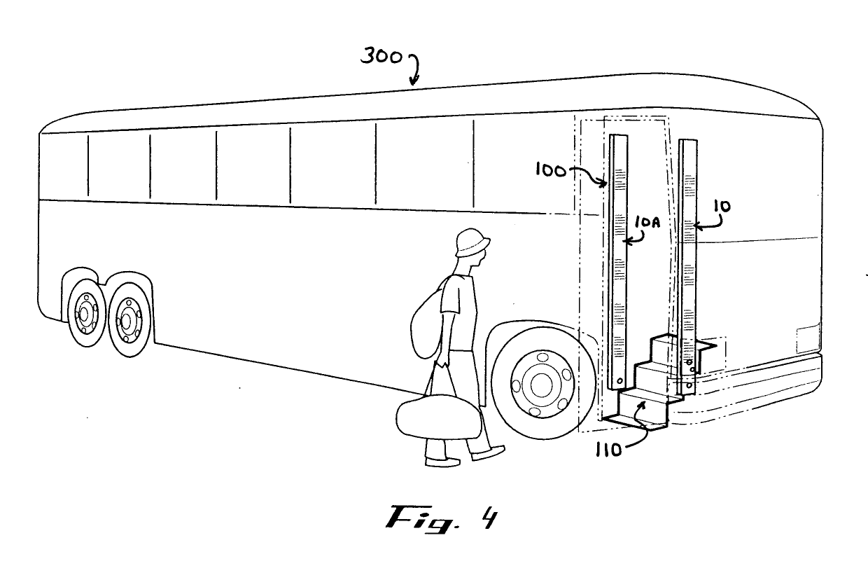

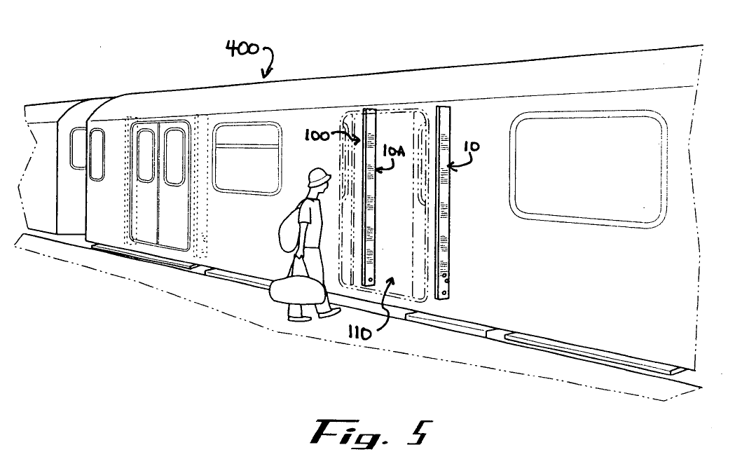

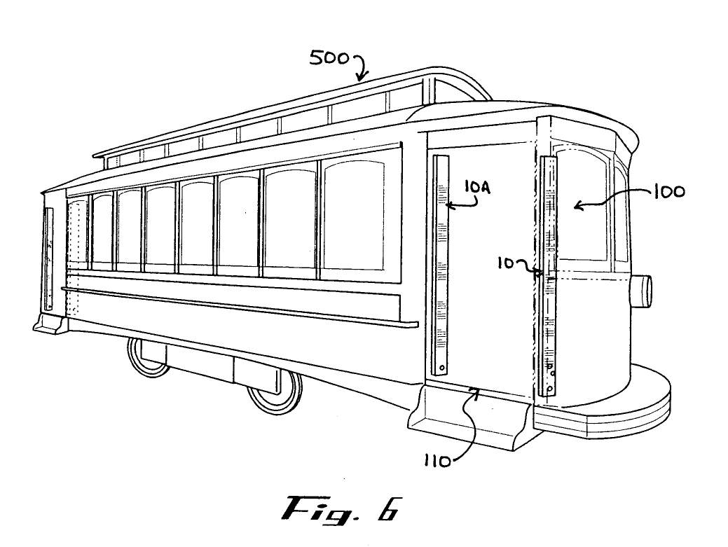

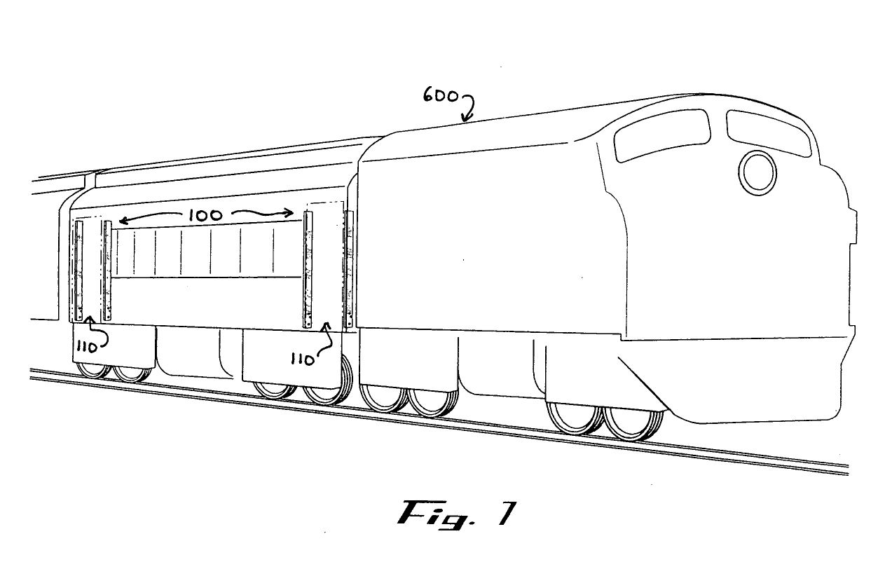

FIGS. 4-7 show various ground-based mass transit vehicles 300, 400, 500, 600 with the point-of-entry security system 100 of the present invention operably installed therein.

While the invention has been particularly shown and described with reference to the preferred embodiment thereof, it will be understood by those skilled in the art that various alterations in form, detail and construction may be made therein without departing from the spirit and scope of the invention.

The embodiments of the invention in which an exclusive property right or privilege is claimed are defined as follows:

1. A point-of-entry security system for ground-based mass transit vehicles comprises:
an electromagnetic field generator comprising a pair of induction coil sending/receiving units mounted at either side of the doorway or entranceway of said mass transit vehicle for detecting metallic objects passing through the electromagnetic field produced by said generator;
means for providing electric energy to, and for controlling the sensitivity of, said generator; and,
means for generating audio and/or visual signals when a metallic object of predetermined size or density is encountered by said electromagnetic field.

2. The apparatus of claim 1, wherein said sending/receiving units comprise vertical posts having electromagnetic induction coils housed therein capable of generating a balanced magnetic field between said sending/receiving units of sufficient strength for detection of metallic objects entering said magnetic field.

3. The apparatus of claim 2, wherein said vertical posts further comprise a hinge joint for collapsing and securing said posts during vehicle movement or when the security system is not in use.

4. The apparatus of claim 1, wherein said means for providing electric energy to, and for controlling the sensitivity of, said generator comprises one or more electric circuits operably attached to said pair of sending/receiving units and to an electric energy source.

5. The apparatus of claim 1, wherein said means for generating audio and/or visual signals when a metallic object is encountered by the electromagnetic field produced by said generator comprises a vehicle operator display unit attached to said means for providing electric energy to, and for controlling the sensitivity of, said generator, which provides the operator of said mass transit vehicle with audible and/or visible warnings of metallic objects detected by the magnetic field produced by said generator.

6. The apparatus of claim 1, further comprising a means for generating wireless transmission of data and/or warning signals to remote locations when a metallic object of predetermined size or density is encountered by said electromagnetic field.

7. A method of detecting metallic objects in the possession of passengers attempting to board ground-based mass transit vehicles comprising the steps of:
installing an electromagnetic field generator comprising a pair of induction coil sending/receiving units at the doorway or entranceway of said vehicle; and,
connecting said electromagnetic field generator to a vehicle operator display unit which generates audio and/or visual signals when a metallic object of predetermined size or density is encountered by electromagnetic field produced by said electromagnetic field generator.

8. The method of claim 7, comprising a further step of wirelessly transmitting the audio and/or visual signals produced by said vehicle operator display unit to remote locations.
